(19) United States
(12) Patent Application Publication
(10) Pub. No.: US 2020/0312597 A1
(43) Pub. Date: Oct. 1, 2020

(54) CONTACT DEVICE AND ELECTROMAGNETIC RELAY EQUIPPED WITH CONTACT DEVICE

(71) Applicant: PANASONIC INTELLECTUAL PROPERTY MANAGEMENT CO., LTD., Osaka (JP)

(72) Inventor: Masahiro ITO, Hyogo (JP)

(73) Assignee: PANASONIC INTELLECTUAL PROPERTY MANAGEMENT CO., LTD., Osaka (JP)

(21) Appl. No.: 16/651,665

(22) PCT Filed: Sep. 26, 2018
(86) PCT No.: PCT/JP2018/035592

§ 371 Date: Mar. 27, 2020

(30) Foreign Application Priority Data
Sep. 28, 2017 (JP) 2017-188537

(51) Int. Cl. H01H 50/54; H01H 50/20

(52) U.S. Cl. CPC H01H 50/546; H01H 50/20

(57) ABSTRACT

A movable contact of a contact device includes a first contact unit and a second contact unit that come into contact with outer surfaces of fixed terminals and a connecting portion connecting the first contact unit and the second contact unit. Here, the first contact unit separates from the outer surface by moving in a direction that is different from a moving direction of a moving body and that intersects an extending direction of a portion that makes contact with the first contact unit of the outer surface. Also, the second contact unit separates from the outer surface by moving in a direction that is different from the moving direction of the moving body and that intersects an extending direction of a portion that makes contact with the second contact unit of the outer surface.

### TECHNICAL FIELD

The present invention relates to a contact device and an electromagnetic relay equipped with the contact device.

### BACKGROUND ART

There has heretofore been known a contact device including a fixed terminal and a movable contact that comes into contact with and separates from the fixed terminal (see, for example, Patent Literature 1).

In this Patent Literature 1, paired contact pieces each have one end in contact with the distal end of a movable contact, and the contact pieces face each other in the up-down direction. In order to electrically connect the movable contact and the fixed terminal, the movable contact is pushed toward the fixed terminal so that the fixed terminal is inserted between the other ends of the paired contact pieces.

### CITATION LIST

### Patent Literature

Patent Literature 1: Japanese Utility Model Registration Application Publication No. S61-010012

### SUMMARY OF INVENTION

### Technical Problem

However, in the above conventional technique, when the fixed terminal is inserted between the other ends of the paired contact pieces, the other ends of the paired contact pieces facing each other in the up-down direction slide on the side surfaces of the fixed terminal. Thus, the frictional force caused when the movable contact is being brought into contact with or separated from the fixed terminal is large. This can hinder the movement of the movable contact, and there is a risk that switching of the contact may not be smooth.

Hence, an object of the present invention is to provide a contact device capable of switching the contact more smoothly and an electromagnetic relay equipped with the contact device.

### Solution to Problem

A contact device according to the present invention includes: a fixed terminal; a movable contact that comes into contact with and away from the fixed terminal; and a drive unit including a moving body that moves the movable contact. The movable contact includes a first contact unit that is formed on one side of the movable contact and comes into contact with an outer surface of the fixed terminal, a second contact unit that is formed on the other side of the movable contact and comes into contact with an outer surface of the fixed terminal, and a connecting portion connecting the first contact unit and the second contact unit. Here, the first contact unit separates from the outer surface by moving in a direction that is different from a moving direction of the moving body and that intersects an extending direction of a portion that makes contact with the first contact unit of the outer surface. The second contact unit separates from the outer surface by moving in a direction that is different from the moving direction of the moving body and that intersects an extending direction of a portion that makes contact with the second contact unit of the outer surface.

An electromagnetic relay according to the present invention includes the contact device.

### Advantageous Effects

The present invention provides a contact device capable of switching the contact more smoothly and an electromagnetic relay equipped with the contact device.

### BRIEF DESCRIPTION OF DRAWINGS

FIG. 1 is a perspective view of an electromagnetic relay according to an embodiment of the present invention.

FIG. 2 is a diagram illustrating a contact device according to an embodiment of the present invention, which is a side cross-sectional view of the contact device with its contacts on, taken along the right-left direction.

FIG. 3 is a diagram illustrating the contact device according to the embodiment of the present invention, which is a side cross-sectional view of the contact device with its contacts off, taken along the right-left direction.

FIG. 4 is a diagram schematically illustrating contact units according to the embodiment of the present invention, which is a partially cutaway side view of the contact units seen along the right-left direction.

FIG. 5 is a diagram schematically illustrating the contact units according to the embodiment of the present invention, which is a bottom view of the contact units seen from the bottom side.

FIG. 6 is a side view of a movable contact according to the embodiment of the present invention.

FIG. 7 is a perspective view diagram schematically illustrating the contact units according to the embodiment of the present invention.

FIG. 8 is a diagram schematically illustrating the contact units according to the embodiment of the present invention, which is a cross-sectional view of the contact units with their contacts on, taken along a horizontal plane.

FIG. 9 is a diagram schematically illustrating contact units according to a first modification, which is a cross-sectional view of the contact units with their contacts on, taken along a horizontal plane.

FIG. 10 is a diagram schematically illustrating contact units according to a second modification, which is a cross-sectional view of the contact units with their contacts on, taken along a horizontal plane.

FIG. 11 is a diagram schematically illustrating contact units according to a third modification, which is a cross-sectional view of the contact units with their contacts on, taken along a horizontal plane.

FIG. 12 is a diagram schematically illustrating contact units according to a fourth modification, which is a partially cutaway side view of the contact units seen along the right-left direction.

FIG. 13 is a diagram schematically illustrating the contact units according the fourth modification, which is a bottom view of the contact units seen from the bottom side.

FIG. 14 is a diagram schematically illustrating the contact units according the fourth modification, which is a partially cutaway side view of the contact units seen along the front-back direction.

FIG. 15 is a diagram illustrating a contact device according to a fifth modification, which is a side cross-sectional view of the contact device with their contacts on, taken along the right-left direction.

FIG. 16 is a diagram schematically illustrating contact units according to a sixth modification, which is a cross-sectional view of the contact units with their contacts on, taken along a horizontal plane.

FIG. 17 is a diagram schematically illustrating contact units according to a seventh modification, which is a cross-sectional view of the contact units with their contacts on, taken along a horizontal plane.

FIG. 18 is a diagram illustrating a contact device according to another embodiment of the present invention, part (a) is a cross-sectional view of the contact device with its contacts off, taken along the right-left direction, and part (b) is a cross-sectional view of the contact device with its contacts on, taken along the right-left direction.

### DESCRIPTION OF EMBODIMENTS

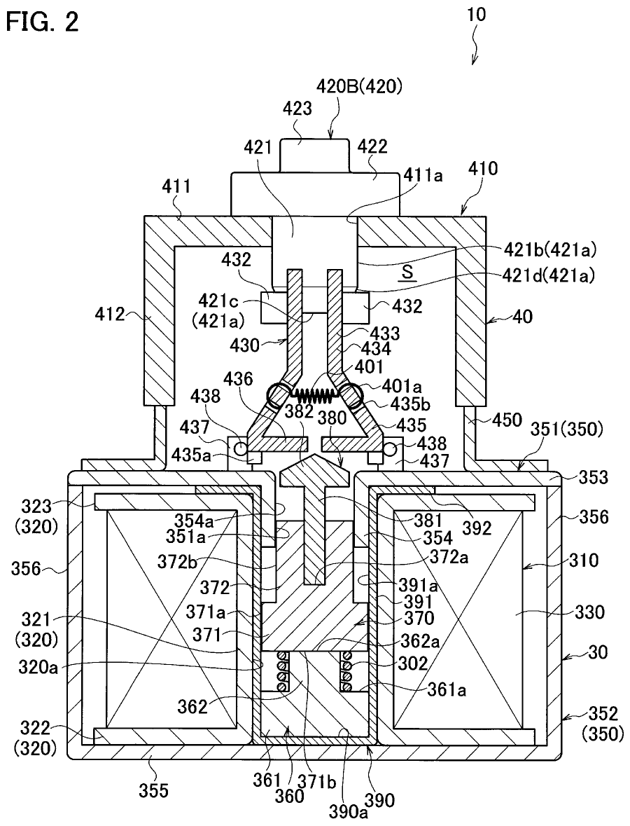

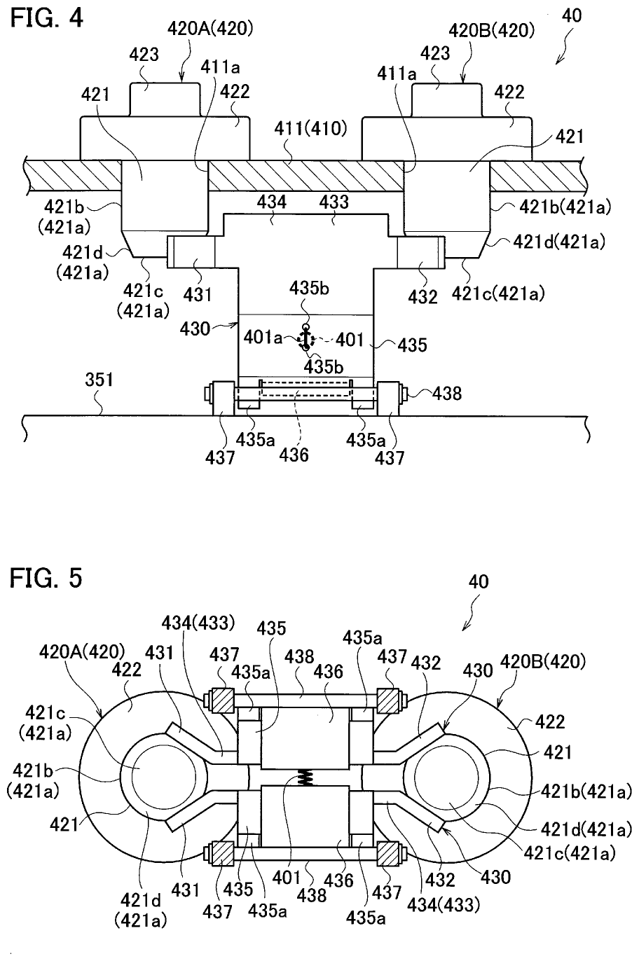

Hereinafter, an embodiment of the present invention will be described in detail with reference to the drawings. Note that the following description is given assuming that the up, down, left, and right in FIG. 2 indicate the up, down, left, and right in the description, and that the right-left direction in FIG. 4 indicates the front-rear direction in the description.

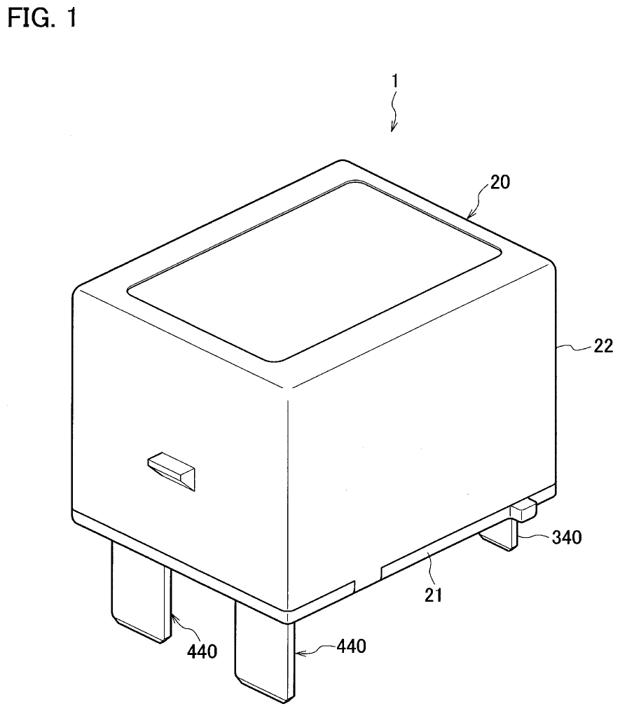

An electromagnetic relay 1 according to this embodiment is of a so-called normally-open type in which the contact is off in an initial state. This electromagnetic relay 1 is equipped with a contact device 10 with a configuration in which a drive block (drive unit) 30 located below and a contact block (contact unit) 40 located above are integrally combined, as shown in FIGS. 1 to 3. To be more specific, in the electromagnetic relay 1 equipped with the contact device 10, the contact device 10 is housed in a hollow box-shaped case 20 formed of a resin material into a hollow box shape. Note that it is also possible to use a so-called normally-closed electromagnetic relay in which the contact is on in an initial state.

As shown in FIGS. 1 and 2, the case 20 includes an approximately rectangular case base 21 and a case cover 22 arranged to cover the case base 21. The case cover 22 is formed in a hollow box shape in which the case base 21 side is open. The mounted parts such as the drive block 30 and the contact block 40 are housed in the internal space of the case 20 formed by attaching the case cover 22 to the case base 21.

A pair of slits (not shown) are provided on the lower side of the case base 21, into which a pair of coil terminals 340, 340 are inserted, respectively. On the upper side of the case base 21 are provided a pair of slits (not shown), into which a pair of bus bars (conductive members) 440 are inserted, respectively.

The drive block 30 includes a coil unit 310. This coil unit 310 includes: a coil 330 that generates a magnetic flux when energized; a hollow cylindrical coil bobbin 320 around which the coil 330 is wound; and the pair of coil terminals 340, 340 fixed to the coil bobbin 320 and connected to both ends of the coil 330.

The coil bobbin 320 is formed of a resin that is an insulating material, and has, at its center, an insertion hole 320a passing through the coil bobbin 320 in the up-down direction. The coil bobbin 320 includes an approximately cylindrical winding drum part 321 having the coil 330 wound on the outer surface thereof. The coil bobbin 320 also includes an approximately circular lower flange part 322 connected to the lower end of the winding drum part 321 so as to protrude radially outward of the winding drum part 321 and an approximately circular upper flange part 323 connected to the upper end of the winding drum part 321 so as to protrude radially outward of the winding drum part 321.

The coil terminal 340 can be formed in a flat plate shape using a conductive material such as copper, for example. The coil terminals 340, 340 have relay terminals (not shown) provided thereon, respectively. A lead wire at one end of the coil 330 wound around the winding drum part 321 of the coil bobbin 320 is soldered in a tangled state to the relay terminal of one of the coil terminals 340. Likewise, a lead wire at the other end of the coil 330 wound around the winding drum part 321 of the coil bobbin 320 is soldered in a tangled state to the relay terminal of the other coil terminal 340.

As described above, in this embodiment, the coil unit 310 is formed by electrically connecting the both ends of the coil 330 wound around the winding drum part 321 of the coil bobbin 320 to the pair of coil terminals 340, 340 fixed to the coil bobbin 320. Thus, the drive block 30 is driven when the coil 330 is energized through the pair of coil terminals 340, 340. When the drive block 30 is driven by energizing the coil 330, the contacts of the contact block 40 to be described later is opened and closed. In this embodiment, the contact block 40 has a pair of contacts. One of the contacts of the contact block 40 is formed by a tapered surface 421d of one of the fixed terminals 420 (first fixed terminal 420A) and first contact units 431 of the movable contacts 430. The other contact is formed by a tapered surface 421d of the other fixed terminal 420 (second fixed terminal 420B) and second contact units 432 of the movable contacts 430. In this embodiment, as described above, the open/close state of the contacts of the contact block 40 can be switched by driving the drive block 30 and stopping driving the drive block 30. In other words, the electrical connection and disconnection between the one fixed terminal 420 and the other fixed terminal 420 can be switched by switching the on/off state of the drive block 30.

The drive block 30 includes a yoke 350 disposed around the coil 330. This yoke 350 can be formed using a magnetic material, for example. In this embodiment, the yoke 350 is arranged so as to surround the coil bobbin 320. The yoke 350 includes a rectangular yoke upper plate 351 arranged on the upper end surface side of the coil bobbin 320 and a rectangular yoke main body 352 arranged on the lower end surface side and the side surface sides of the coil bobbin 320.

The yoke main body 352 is arranged between the coil 330 and the case 20. In this embodiment, the yoke main body 352 includes a bottom wall 355 and a pair of side walls 356, 356 that rise from the left and right end edges (peripheral edges) of the bottom wall 355, respectively, which are open in the front-rear direction. Note that the bottom wall 355 and the pair of side walls 356, 356 can be formed into a continuous and integrated part by bending a single plate.

On the distal end side (upper end side) of the pair of side walls 356, 356 of the yoke main body 352, the yoke upper plate 351 described above is arranged so as to cover the upper end surface of the coil bobbin 320 and the coil 330 wound around the coil bobbin 320.

This yoke upper plate 351 has an insertion hole 351a passing through it in the up-down direction. The yoke upper plate 351 in this embodiment includes a flat plate portion 353 in an approximately rectangular plate shape that covers the upper-end surface of the coil bobbin 320 and the coil 330 wound around the coil bobbin 320 and a tubular portion 354 connected to the approximately center portion of the flat plate portion 353 and extending downward. The space inside the tubular portion 354 serves as the insertion hole 351a of the yoke upper plate 351.

The drive block 30 includes a fixed iron core (fixed-side member) 360 that is inserted into the cylinder part (in the insertion hole 320a) of the coil bobbin 320 and is magnetized by the coil 330 (through which a magnetic flux passes) when the coil 330 is energized. The drive block 30 further includes a movable iron core (movable-side member) 370 that is opposed to the fixed iron core 360 in the up-down direction (axial direction) and is disposed inside the cylinder part (inside the insertion hole 320a) of the coil bobbin 320.

The fixed iron core 360 in this embodiment has an approximately protruding shape in cross-sectional view and includes a large-diameter cylindrical portion 361 and a small-diameter cylindrical portion 362 connected to the upper part of the large-diameter cylindrical portion 361. The entire fixed iron core 360 is inserted into the cylindrical portion (in the insertion hole 320a) of the coil bobbin 320.

The movable iron core 370 also has an approximately protruding shape in cross-sectional view and includes a large-diameter cylindrical portion 371 and a small-diameter cylindrical portion 372 connected to the upper part of this large-diameter cylindrical portion 371. This small-diameter cylindrical portion 372 has, in its center, a press-fitting recess (insertion receiving portion) 372a that is open upward and into which a shaft 380 is press-fitted (inserted). This press-fitting recess 372a has an approximately constant opening diameter (opening diameter approximately the same as the diameter of the shaft main body 381).

The shaft 380 can be formed of, for example, a non-magnetic material. In this embodiment, the shaft 380 includes: the shaft main body 381 having a round bar shape elongated in the moving direction of the movable iron core 370 (up-down direction: drive shaft direction); and an approximately umbrella-shaped head 382 connected to the upper part of the shaft main body 381. The movable iron core 370 and the shaft 380 are connected by inserting the lower end of the shaft main body 381 into the press-fitting recess 372a of the small-diameter cylindrical portion 372 from above.

In this embodiment, the drive block 30 further includes a plunger cap 390 formed in a cylindrical shape with a bottom and an open top. This plunger cap 390 can also be formed using a non-magnetic material, for example. The plunger cap 390 is disposed between the fixed iron core 360 and the coil bobbin 320, and between the movable iron core 370 and the coil bobbin 320.

In this embodiment, the plunger cap 390 includes: a main body part 391 having a cylindrical shape with a bottom and an open top; and a flange part 392 that protrudes radially outward from the upper end of the main body part 391. The main body part 391 of the plunger cap 390 is arranged in the insertion hole 320a formed at the center of the coil bobbin 320. Note that an annular seat surface may be formed on the upper side (the upper flange part 323) of the coil bobbin 320, and the flange part 392 may be placed on the seat surface when the main body part 391 of the plunger cap 390 is placed in the insertion hole 320a of the coil bobbin 320.

The fixed iron core 360 and the movable iron core 370 are housed in a housing space 390a of the plunger cap 390 provided inside the cylindrical part of the coil bobbin 320 (inside the insertion hole 320a). In this embodiment, the movable iron core 370 is arranged on the opening side of the plunger cap 390, while the fixed iron core 360 is arranged below the movable iron core 370 in the cylinder of the plunger cap 390. Then, between the fixed iron core 360 and the movable iron core 370 is arranged a return spring 302 that biases the movable iron core 370 in the direction away from the fixed iron core 360 by the elastic force.

The large-diameter cylindrical portion 361 of the fixed iron core 360, the large-diameter cylindrical portion 371 of the movable iron core 370, and the tubular portion 354 of the yoke upper plate 351 each are formed in a columnar shape having an outer diameter approximately the same as the inner diameter of the plunger cap 390. The outer diameter of the small-diameter cylindrical portion 372 of the movable iron core 370 is formed in a columnar shape having approximately the same diameter as the inner diameter of the tubular portion 354 of the yoke upper plate 351.

The fixed iron core 360 and the movable iron core 370 are housed inside the plunger cap 390, and the small-diameter cylindrical portion 372 is inserted into the tubular portion 354 while the tubular portion 354 is inserted into the plunger cap 390. Thus, the yoke upper plate 351 is placed on the upper-end surface side of the coil bobbin 320. Here, when the yoke upper plate 351 is placed on the upper-end surface side of the coil bobbin 320, the flange part 392 formed on the opening side of the plunger cap 390 is fixed to the periphery of the insertion hole 351a on the lower surface of the yoke upper plate 351. The bottom part of the lower end of the plunger cap 390 is placed on the bottom wall 355.

With the above configuration, when the drive unit 30 is driven, a magnetic circuit is formed by the yoke 350 (the yoke upper plate 351 and the yoke main body 352), the fixed iron core 360, and the movable iron core 370. When driving of the drive unit 30 is switched on or off, the movable iron core 370 slides in the up-down direction (reciprocating direction: drive shaft direction) in the housing space 390a of the plunger cap 390. Specifically, the movable iron core 370 reciprocates in the up-down direction with the side surface 371a of the large-diameter cylindrical portion 371 in contact with and sliding on the inner surface 391a of the main body part 391 of the plunger cap 390 and also with the side surface 372b of the small-diameter cylindrical portion 372 in contact with and sliding on the inner surface 354a of the tubular portion 354.

Note that the shaft 380 attached to the movable iron core 370 is inserted from below into the tubular portion 354 (insertion hole 351a), and the head 382 side of this shaft 380 is configured to protrude upward from the yoke upper plate 351. Specifically, the upper end side (head 382 side) of the shaft 380 is configured to stretch through the insertion hole 351a of the yoke upper plate 351 into the contact block 40.

When the coil 330 is energized, and the movable iron core 370 is attracted to the fixed iron core 360, the movable iron core 370 moves downward together with the shaft 380 connected and fixed to the movable iron core 370.

Note that, in this embodiment, a range (movable range) within which the movable iron core 370 can move is set between an initial position which is gap D1 away upward from the fixed iron core 360 and a contact position at which the movable iron core 370 comes into contact with the fixed iron core 360. Note that in this embodiment, the initial position is defined as the position at which the movable iron core 370 is farthest from the fixed iron core 360 in the state where the drive block 30 is assembled, and the contact position is defined as the position at which the movable iron core 370 is closest to the fixed iron core 360 in the assembled state.

As described above, the return spring 302 is disposed between the fixed iron core 360 and the movable iron core 370, and the elasticity of the return spring 302 biases the movable iron core 370 in the direction in which the movable iron core 370 moves to return to the initial position (direction in which the movable iron core 370 moves away from the fixed iron core 360). In this embodiment, the return spring 302 is a coil spring arranged on the upper surface (step surface) 361a of the large-diameter cylindrical portion 361 so as to be wound around the small-diameter cylindrical portion 362. The upper end of the return spring 302 is in contact with the lower surface 371b of the large-diameter cylindrical portion 371 of the movable iron core 370, and the lower end is in contact with the upper surface 361a of the large-diameter cylindrical portion 361 of the fixed iron core 360. That is, the lower surface 371b of the large-diameter cylindrical portion 371 and the upper surface 361a of the large-diameter cylindrical portion 361 serve as spring receiving parts for the return spring 302.

With the above configuration, when the coil 330 is energized, the surface of the fixed iron core 360 facing the movable iron core 370 (the upper surface 362a of the small-diameter cylindrical portion 362) and the surface of the movable iron core 370 facing the fixed iron core 360 (the lower surface 371b of the large-diameter cylindrical portion 371) have different polarities as a pair of magnetic pole parts. Then, the movable iron core 370 is attracted to the fixed iron core 360 and moves toward the contact position. Thus, in this embodiment, when the coil 330 is energized, the surface of the fixed iron core 360 facing the movable iron core 370 (the upper surface 362a of the small-diameter cylindrical portion 362) and the surface of the movable iron core 370 facing the fixed iron core 360 (the lower surface 371b of the large-diameter cylindrical portion 371) function as magnetic pole surfaces.

When the current supply to the coil 330 is stopped, the movable iron core 370 is returned to the initial position by the biasing force of the return spring 302.

As described above, the movable iron core 370 reciprocates in such a manner as to be positioned being opposed to the fixed iron core 360 with gap D1 in between when the coil 330 is not energized and be attracted to the fixed iron core 360 side when the coil 330 is energized.

Along with the reciprocation of the movable iron core 370 in the up-down direction, the shaft 380 reciprocates in the up-down direction. Along with the reciprocation of the shaft 380 in the up-down direction, the movable contacts 430 move relative to the fixed terminals 420 (the first fixed terminal 420A and the second fixed terminal 420B). Thus, in this embodiment, the shaft 380 corresponds to the moving body that moves the movable contacts 430 relative to the first fixed terminal 420A and the second fixed terminal 420B by reciprocating in the up-down direction (moving direction, one direction).

Above the drive block 30 is provided the contact block 40 that opens and closes the contacts according to the on/off state of the current supply to the coil 330.

The contact block 40 includes a base 410 formed of a heat-resistant material such as ceramic into a box shape with an open bottom. This base 410 includes a top wall 411 and an approximately rectangular cylindrical peripheral wall 412 extending downward from the peripheral portions of the top wall 411.

The top wall 411 of the base 410 has two insertion holes 411a, 411a provided therein so as to be lined in the right-left direction. The first fixed terminal 420A is inserted into one (on the left side in FIG. 4) of the two insertion holes 411a, 411a, while the second fixed terminal 420B is inserted into the other (on the right side in FIG. 4) insertion hole 411a. In this embodiment, for the sake of convenience, the first fixed terminal 420A and the second fixed terminal 420B are used to distinguish between a pair of fixed terminals that are electrically connected to each other. However, it is not necessary that one fixed terminal (the left fixed terminal in FIG. 4) be the first fixed terminal 420A and the other fixed terminal (the right fixed terminal in FIG. 4) be the second fixed terminal 420B. That is, one fixed terminal (the left fixed terminal in FIG. 4) may be the second fixed terminal 420B and the other fixed terminal (the right fixed terminal in FIG. 4) may be the first fixed terminal 420A.

Each fixed terminal 420 is formed of a conductive material such as a copper-based material, and is arranged so as to be elongated in the up-down direction in the state shown in FIG. 4. In this embodiment, each fixed terminal 420 includes an approximately cylindrical fixed terminal main body 421 (fixed terminal main body 421 elongated in the up-down direction) inserted into the insertion hole 411a from above, and has, at the lower end of the fixed terminal main body 421, a tapered portion the diameter of which decreases toward its lower side.

Thus, the fixed terminal main body 421 of each fixed terminal 420 has an outer surface 421a formed so as to have a side surface 421b extending in the vertical direction (up-down direction), a bottom surface 421c extending in the horizontal direction (the front-rear direction and the right-left direction), and the tapered surface 421d extending in oblique directions.

The fixed terminal 420 includes an approximately disk-shaped flange part 422 that protrudes radially outward from the upper end of the fixed terminal main body 421, and is fixed to the upper surface of the top wall 411 (the upper surface of the peripheral portion of the insertion hole 411a).

The fixed terminals 420 in this embodiment are fixed to the top wall 411 with the insertion holes 411a closed, using not-shown silver solder and washers. Note that although in this embodiment, the first fixed terminals 420 are fixed to the top wall 411 such that their longitudinal direction approximately agrees with the up-down direction, it is not necessary to make the longitudinal direction of the fixed terminals 420 approximately in agreement with the up-down direction.

Here, the pair of fixed terminals 420, 420 are fixed (disposed) to the top wall 411 to be spaced from each other. Then, the upper and lower sides of the fixed terminal 420 are partitioned by the top wall 411 in a state where the fixed terminal 420 is fixed to the top wall 411.

The bus bars (conductive members) 440 to be connected to an external load or the like are attached to the respective fixed terminals 420.

The bus bar 440 is formed of a conductive material, and this bus bar 440 has a not-shown insertion hole. A projection 423 provided at the center of the flange part 422 so as to project upward is inserted into the insertion hole of the bus bar 440 and caulked, and thereby, the bus bar 440 is fixed to the fixed terminal 420.

In the base 410, the movable contacts 430 are disposed so as to be movable relative to the fixed terminals 420 along with the movement of the shaft (drive shaft) 380 in the up-down direction (one direction).

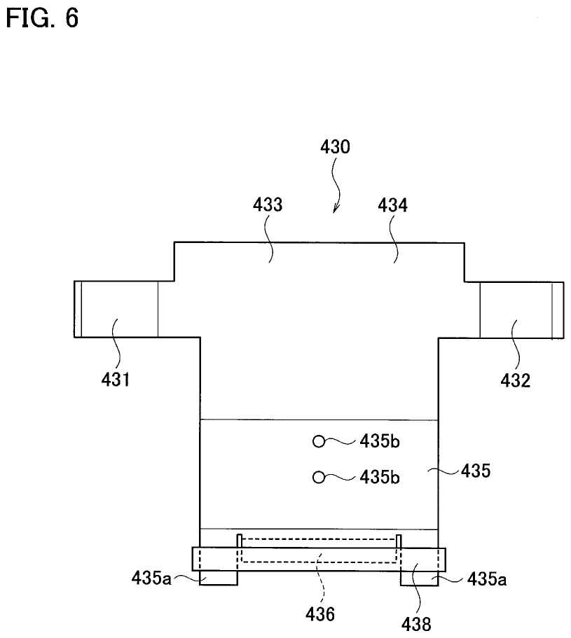

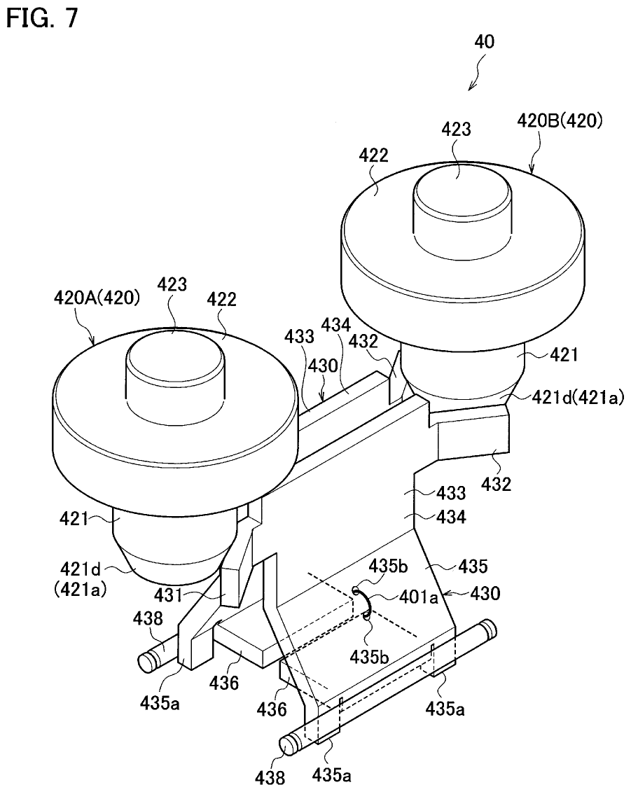

In this embodiment, the movable contact 430 is formed of an approximately plate-shaped member as shown in FIGS. 4 to 8 and includes a first contact unit 431 formed on one side of the movable contact 430, a second contact unit 432 formed on the other side of the movable contact 430, and a connecting portion 433 connecting the first contact unit 431 and the second contact unit 432. Note that the connecting portion 433 in this embodiment includes a connecting portion main body 434, and the first contact unit 431 and the second contact unit 432 are respectively connected to both ends of this connecting portion main body 434.

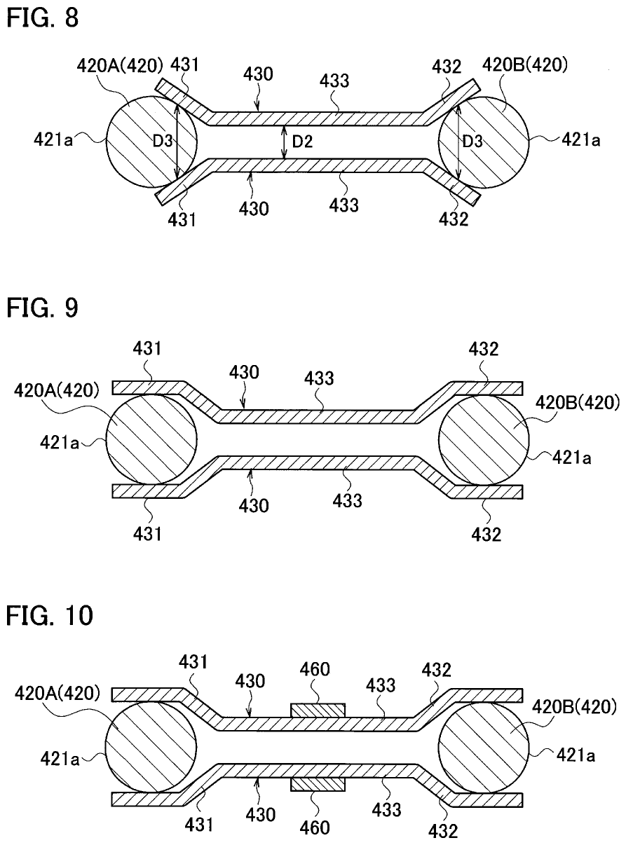

The pair of movable contacts 430, 430 are arranged to face each other such that the pair of fixed terminals 420 (the first fixed terminal 420A and the second fixed terminal 420B) are positioned between the pair of movable contacts 430, 430 (see FIG. 8). In this embodiment, one of the movable contacts 430 is arranged on the left side in the right-left direction of the pair of fixed terminals 420 (the first fixed terminal 420A and the second fixed terminal 420B) lined in the front-back direction, and the other movable contact 430 is arranged on the right side in the right-left direction of the pair of fixed terminals 420.

Thus, in this embodiment, each movable contact 430 has a plate shape elongated in the front-back direction, including the first contact unit 431, the second contact unit 432, and the connecting portion main body 434. In addition, when viewed in the right-left direction, the connecting portion main body 434 (connecting portion 433) is positioned between the inner end of the first fixed terminal 420A (the portion closest to the second fixed terminal 420B) and the inner end of the second fixed terminal 420B (the portion closest to the first fixed terminal 420A) (see FIG. 4).

Then, the first contact unit 431 extending to protrude on one side in the front-back direction of the connecting portion main body 434 (on the first fixed terminal 420A side) is formed, when viewed in the right-left direction, to face (overlap) the tapered surface 421d of the first fixed terminal 420A. The second contact unit 432 extending to protrude on the other side in the front-back direction of the connecting portion main body 434 (on the second fixed terminal 420B side) is formed, when viewed in the right-left direction, to face (overlap) the tapered surface 421d of the second fixed terminal 420B.

The first contact unit 431 and the second contact unit 432 are connected to the connecting portion main body 434 (connecting portion 433) so as to be bent, when viewed in the up-down direction, in the same direction relative to the connecting portion main body 434 extending approximately in the front-back direction (see FIG. 8). Specifically, for the movable contact 430 arranged on the left side in the right-left direction, the first contact unit 431 and the second contact unit 432 are connected to the connecting portion main body 434 such that their distal ends are positioned, when viewed in the up-down direction, on the left side of the connecting portion main body 434. For the movable contact 430 arranged on the right side in the right-left direction, the first contact unit 431 and the second contact unit 432 are connected to the connecting portion main body 434 such that their distal ends are positioned, when viewed in the up-down direction, on the right side of the connecting portion main body 434.

Each movable contact 430 in this embodiment is arranged in the base 410 to be rotatable on a rotation shaft 438 extending in the front-back direction. Then, the reciprocation of the shaft 380 in the up-down direction rotates each movable contact 430 such that the first contact unit 431 and the second contact unit 432 come into contact with or separate from the fixed terminals 420.

Specifically, the connecting portion 433 includes an extension portion 435 connected to the lower end of the connecting portion main body 434 and extending downward, and the rotation shaft 438 is fixed to the lower end of this extension portion 435. Then, the rotation shaft 438 fixed to the lower end of the extension portion 435 is rotatably supported by a pair of bearings 437,437. This pair of bearings 437,437 are fixed on the yoke upper plate 351.

In addition, to the lower end of the extension portion 435 is connected a pressing-force receiving piece 436 extending inward (extending toward the movable contact 430 on the other side) and configured to be pressed by the head 382 of the shaft 380. This pressing-force receiving piece 436 in this embodiment is formed integrally with the extension portion 435 by bending inward the center portion in the front-back direction of the lower end of the extension portion 435. On both sides in the front-back direction of the lower end of the extension portion 435 are formed piece portions 435a extending downward, and the rotation shaft 438 is fixed to these piece portions 435a, 435a.

In this embodiment, the pair of movable contacts 430, 430 are connected to each other via a contact pressure spring 401. The pair of movable contacts 430, 430 are biased in the directions toward each other (in the directions toward the fixed terminal 420) by this contact pressure spring 401. Thus, the contact pressure spring 401 provides the contact pressure between the movable contact 430 and the fixed terminal 420 in this embodiment. The contact pressure spring 401 is a coil spring and is arranged with the axial direction oriented in the right-left direction. In this embodiment, each of the hook portions 401a formed at both ends of the coil spring is hooked in engagement holes 435b formed in the extension portion 435 of each movable contact 430, and thereby the pair of movable contacts 430, 430 are connected to each other by the contact pressure spring 401.

With the movable contacts 430 as described above, when the shaft (moving body, drive shaft) 380 moves downward (in one direction) in the up-down direction (moving direction), the head 382 of the shaft 380 stops pressing the pressing-force receiving pieces 436. When the head 382 of the shaft 380 stops pressing the pressing-force receiving piece 436, the paired movable contacts 430, 430 are rotated by the biasing force (elastic restoring force) of the contact pressure spring 401 such that their upper sides come close to each other. When the upper sides of the paired movable contacts 430, 430 rotate in the directions toward each other as described above, the first contact units 431 move relative to the first fixed terminal 420A and come into contact with the tapered surface 421d (outer surface 421a) of the first fixed terminal 420A. The second contact units 432 also move relative to the second fixed terminal 420B and come into contact with the tapered surface 421d (outer surface 421a) of the second fixed terminal 420B. Thus, the first fixed terminal 420A and the second fixed terminal 420B are brought into a conductive state.

On the other hand, when the shaft (drive shaft) 380 moves upward (in the other direction) in the up-down direction (moving direction), the pressing-force receiving pieces 436 are pressed by the head 382 of the shaft 380. When the pressing-force receiving pieces 436 are pressed by the head 382 of the shaft 380, the paired movable contacts 430, 430 rotate against the biasing force (elastic restoring force) of the contact pressure spring 401 such that their upper sides move away from each other. When the upper sides of the paired movable contacts 430, 430 rotate in the direction away from each other as described above, the first contact units 431 move relative to the first fixed terminal 420A and separate from the tapered surface 421d (the outer surface 421a) of the first fixed terminal 420A. The second contact units 432 also move relative to the second fixed terminal 420B and separate from the tapered surface 421d (the outer surface 421a) of the second fixed terminal 420B. Thus, the first fixed terminal 420A and the second fixed terminal 420B are brought into a non-conductive state.

As described above, the drive block (drive unit) 30 according to this embodiment has the shaft (moving body, drive shaft) 380 that drives (moves) the movable contacts 430.

Then, the movement of the shaft (moving body) 380 in the up-down direction (moving direction) causes the relative rotation (relative movement) of the movable contacts 430 in the right-left direction relative to the pair of fixed terminals 420, and this operation switches the conduction and non-conduction between the fixed terminals.

Here, the first contact unit 431 rotates in a direction approximately orthogonal to (intersecting) the extending directions of the tangent plane to the portion of the outer surface 421a of the first fixed terminal 420A with which the first contact unit 431 comes into contact. Specifically, in this embodiment, the first contact unit 431 separates from the tapered surface 421d (outer surface 421a) by moving in a direction that is different from the moving direction (up-down direction) of the shaft (moving body) 380 and that intersects the extending directions of the portion that makes contact with the first contact unit 431 of the tapered surface 421d (outer surface 421a).

The second contact unit 432 also rotates in a direction approximately orthogonal to (intersecting) the extending directions of the tangent plane to the portion of the outer surface 421a of the second fixed terminal 420B with which the second contact unit 432 comes into contact. Hence, in this embodiment, the second contact unit 432 also separates from the tapered surface 421d (outer surface 421a) by moving in a direction that is different from the moving direction (up-down direction) of the shaft (moving body) 380 and that intersects the extending directions of the portion that makes contact with the second contact unit 432 of the tapered surface 421d (outer surface 421a).

In this embodiment, the first contact unit 431 of the movable contact 430 arranged on the left side in the right-left direction comes into contact with the tapered surface 421d (outer surface 421a) of the first fixed terminal 420A by rotating in the right direction. The first contact unit 431 of the movable contact 430 arranged on the right side in the right-left direction comes into contact with the tapered surface 421d (outer surface 421a) of the first fixed terminal 420A by rotating in the left direction.

The second contact unit 432 of the movable contact 430 arranged on the left side in the right-left direction comes into contact with the tapered surface 421d (outer surface 421a) of the second fixed terminal 420B by rotating in the right direction. The second contact unit 432 of the movable contact 430 arranged on the right side in the right-left direction comes into contact with the tapered surface 421d (outer surface 421a) of the second fixed terminal 420B by rotating in the left direction.

As described above, in this embodiment, when the first fixed terminal 420A and the second fixed terminal 420B are electrically connected, the first contact unit 431 of one of the movable contacts 430 and the first contact unit 431 of the other movable contact 430 sandwich the first fixed terminal 420A. The second contact unit 432 of one of the movable contacts 430 and the second contact unit 432 of the other movable contact 430 also sandwich the second fixed terminal 420B.

In addition, in this embodiment, the first contact unit 431 and the second contact unit 432 are connected to the connecting portion main body 434 (connecting portion 433) so as to be bent, when viewed in the up-down direction, in the same direction relative to the connecting portion main body 434 extending approximately in the front-back direction. Then, the first contact unit 431 and the second contact unit 432 are brought into contact with the tapered surfaces 421d (outer surfaces 421a) of the respective fixed terminals 420.

This configuration enables the distance D2 between the connecting portion 433 of one of the movable contacts 430 and the connecting portion 433 of the other movable contact 430 to be smaller than the diameter of the fixed terminals 420 in the state where the first fixed terminal 420A and the second fixed terminal 420B are electrically connected.

In addition, the center portion of each of the first contact unit 431 and the second contact unit 432 comes into contact with the tapered surface 421d (outer surface 421a) of the corresponding fixed terminal 420 at an inner portion in the front-back direction of the tapered surface 421d (a portion of each fixed terminal 420 closer to the other fixed terminal 420 than its own center axis).

Thus, the distance D2 between the connecting portions 433, 433 is smaller than the distance D3 between the portion of the first contact unit 431 of one of the movable contacts 430 that comes into contact with the tapered surface 421d (outer surface 421a) of the first fixed terminal 420A and the portion of the first contact unit 431 of the other movable contact 430 that comes into contact with the tapered surface 421d (outer surface 421a) of the first fixed terminal 420A.

Note that in this embodiment, the distance D2 between the connecting portions 433, 433 is smaller than the distance D3 between the portion of the second contact unit 432 of one of the movable contacts 430 that comes into contact with the tapered surface 421d (outer surface 421a) of the second fixed terminal 420B and the portion of the second contact unit 432 of the other movable contact 430 that comes into contact with the tapered surface 421d (outer surface 421a) of the second fixed terminal 420B.

Further, in this embodiment, a gas is enclosed in the base 410 to suppress arc generated between the movable contacts 430 and the fixed terminals 420. These arcs generate when the movable contacts 430 are separated from the fixed terminals 420. As such a gas, a mixed gas can be used, which is mainly composed of hydrogen gas having the highest heat conductivity in a temperature range where the arc is generated. In order to enclose this gas, an upper flange 450 is provided in this embodiment to cover a gap between the base 410 and the yoke upper plate 351.

Specifically, the base 410, as described above, includes the top wall 411 in which the pair of insertion holes 411a and 411a are arranged in the left-right direction (width direction) and the rectangular cylindrical peripheral wall 412 that extends downward from the periphery of the top wall 411. In other words, this base 410 is formed in a hollow box shape in which the lower side (movable contact 430 side) is open. Then, the base 410 is fixed to the yoke upper plate 351 through the upper flange 450 in the state where the movable contacts 430 put from the lower opening are housed inside the peripheral wall 412.

In this event, the peripheral edge of the opening in the lower surface of the base 410 and the upper surface of the upper flange 450 are hermetically joined with a silver solder, while the lower surface of the upper flange 450 and the upper surface of the yoke upper plate 351 are hermetically joined by arc welding or the like. Furthermore, the lower surface of the yoke upper plate 351 and the flange part 392 of the plunger cap 390 are hermetically joined by arc welding or the like. Thus, a sealed space S with gas sealed therein is formed in the base 410.

Here, in parallel with the arc suppression method using gas, arc suppression using a capsule yoke block 450 may be implemented. This capsule yoke block may be, for example, one constituted of a capsule yoke and permanent magnets, and this capsule yoke block may be arranged outside the peripheral wall 412.

Next, operations of the electromagnetic relay 1 (contact device 10) will be described.

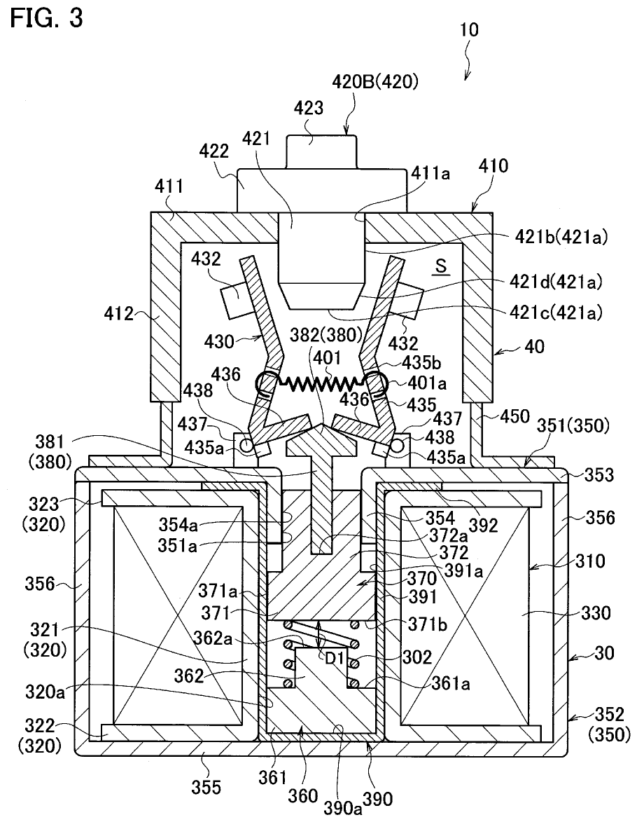

First, when the coil 330 is not energized, the elastic force (elastic restoring force) of the return spring 302 keeps the movable iron core 370 in the state it has been moved in the direction away from the fixed iron core 360. In this state, the head 382 of the shaft 380 presses the pressing-force receiving pieces 436, and the paired movable contacts 430, 430 are rotated such that their upper sides are away from each other against the biasing force (elastic restoring force) of the contact pressure spring 401. Specifically, the paired movable contacts 430 are away from the first fixed terminal 420A and the second fixed terminal 420B, as described in FIG. 3.

Here, when the coil 330 is energized in this off state, the movable iron core 370 is attracted to the fixed iron core (fixed-side member) 360 by the electromagnetic force against the elastic force (elastic restoring force) of the return spring 302, and the movable iron core 370 moves toward the fixed iron core (fixed-side member) 360 (downward). Then, along with the downward movement of the movable iron core 370, the shaft 380 also moves downward. When the shaft 380 moves downward (in one direction), the head 382 of the shaft 380 stops pressing the pressing-force receiving pieces 436, and the paired movable contacts 430, 430 are rotated by the biasing force (elastic restoring force) of the contact pressure spring 401 such that their upper sides come close to each other. When the upper sides of the paired movable contacts 430, 430 rotate in the directions toward each other as described above, the first contact units 431 move relative to the first fixed terminal 420A and come into contact with the tapered surface 421d (outer surface 421a) of the first fixed terminal 420A. The second contact units 432 also move relative to the second fixed terminal 420B and come into contact with the tapered surface 421d (outer surface 421a) of the second fixed terminal 420B. Thus, the first fixed terminal 420A and the second fixed terminal 420B are brought into electrical connection, and the electromagnetic relay 1 (contact device 10) turns on (see FIG. 2).

When the electromagnetic relay 1 (contact device 10) is turned on, as described above, the first contact unit 431 of each movable contact 430 is in contact with the tapered surface 421d of the first fixed terminal 420A. The second contact unit 432 of each movable contact 430 also is in contact with the tapered surface 421d of the second fixed terminal 420B.

In this embodiment, as described above, each of the tapered surface 421d of the first fixed terminal 420A and the tapered surface 421d of the second fixed terminal 420B has two (multiple) contact portions that make contact with the respective movable contacts 430. Thus, the amount (current value) of the electric current that flows through each first contact unit 431 is smaller than the amount (current value) of the electric current that flows through the first fixed terminal 420A. Note that the two movable contact 430 in this embodiment are formed of the same material and have the same shape. Accordingly, the amount (current value) of the electric current that flows through each of the two first contact units 431 is approximately half the amount (current value) of the electric current that flows through the first fixed terminal 420A. Similarly, the amount (current value) of the electric current that flows through each of the two second contact units 432 is approximately half the amount (current value) of the electric current that flows through the second fixed terminal 420B.

Meanwhile, it is known that the magnitude of electromagnetic repulsion force generated when current flows through a contact portion between two members is proportional to the square of the current flowing through the contact portion. Therefore, the electromagnetic repulsion force generated at each of the two first contact units 431 is one-fourth the electromagnetic repulsion force that would be generated at a first contact unit 431 for the case where the first contact unit 431 is brought into contact at one place with the first fixed terminal 420A. Similarly, the electromagnetic repulsion force generated at each of the two second contact units 432 is one-fourth the electromagnetic repulsion force that would be generated at a second contact unit 432 for the case where the second contact unit 432 is brought into contact at one place with the second fixed terminal 420B.

Thus, since the first contact units 431 come into contact with the first fixed terminal 420A at multiple places as described above, the electromagnetic repulsive force that each of the first contact units 431 receives from the first fixed terminal 420A can be smaller than in the case where a first contact unit 431 comes into contact with the first fixed terminal 420A at one place. Also, since the second contact units 432 come into contact with the second fixed terminal 420B at multiple places as described above, the electromagnetic repulsive force that each of the second contact units 432 receives from the second fixed terminal 420B can be smaller than in the case where a second contact unit 432 comes into contact with the second fixed terminal 420B at one place.

This configuration prevents disconnection of the contact between the first contact units 431 and the first fixed terminal 420A and disconnection of the contact between the second contact units 432 and the second fixed terminal 420B. Thus, it is possible to keep more reliably the electrical connection between the first fixed terminal 420A and the second fixed terminal 420B.

When power supply to the coil 330 is stopped, the movable iron core 370 is moved back to the initial position by the biasing force (elastic restoring force) of the return spring 302. Specifically, the movable iron core 370 moves upward. Then, along with the upward movement of this movable iron core 370, the shaft 380 also moves upward, and the pressing-force receiving pieces 436 are pressed by the head 382 of the shaft 380.

Then, when the pressing-force receiving pieces 436 are pressed by the head 382 of the shaft 380, the paired movable contacts 430, 430 rotate against the biasing force (elastic restoring force) of the contact pressure spring 401 such that their upper sides move away from each other. When the upper sides of the paired movable contacts 430, 430 rotate in the directions away from each other as described above, the first contact units 431 move relative to the first fixed terminal 420A and separate from the tapered surface 421d (outer surface 421a) of the first fixed terminal 420A. The second contact units 432 also move relative to the second fixed terminal 420B and separate from the tapered surface 421d (outer surface 421a) of the second fixed terminal 420B. Thus, the first fixed terminal 420A and the second fixed terminal 420B are electrically insulated, and the electromagnetic relay 1 (contact device 10) turns off (see FIG. 3).

As described above, in this embodiment, the contact device 10 includes the fixed terminals 420, the movable contacts 430 that come into contact with and away from the fixed terminals 420, and the drive block (drive unit) 30 having the shaft (moving body) 380 that moves the movable contacts 430.

The movable contact 430 includes the first contact unit 431 formed on one side of the movable contact 430 and comes into contact with the outer surface 421a of the fixed terminal 420, the second contact unit 432 formed on the other side of the movable contact 430 and comes into contact with the outer surface 421a of the fixed terminal 420, and the connecting portion 433 connecting the first contact unit 431 and the second contact unit 432.

The first contact unit 431 separates from the outer surface 421a by moving in a direction that is different from the moving direction (up-down direction) of the shaft (moving body) 380 and that intersects the extending directions of the portion that makes contact with the first contact unit 431 of the outer surface 421a.

The second contact unit 432 separates from the outer surface 421a by moving in a direction that is different from the moving direction (up-down direction) of the shaft (moving body) 380 and that intersects the extending directions of the portion that makes contact with the second contact unit 432 of the outer surface 421a.

This configuration can prevent the first contact unit 431 and the second contact unit from sliding on the outer surface 421a of the fixed terminal 420 when the first contact unit 431 and the second contact unit are being brought into contact with or separated from the outer surface 421a of the fixed terminal 420. In other words, this configuration makes as small as possible the frictional force generated when the first contact unit 431 and the second contact unit are being brought into contact with or separated from the outer surface 421a of the fixed terminal 420. This makes switching of the contact smoother.

The electromagnetic relay 1 according to this embodiment is equipped with the above contact device 10.

Thus, according to this embodiment, it is possible to realize the contact device 10 capable of switching the contact more smoothly and the electromagnetic relay 1 equipped with the contact device 10.

The fixed terminals 420 in this embodiment are constituted of the first fixed terminal 420A and the second fixed terminal 420B spaced from the first fixed terminal 420A.

Then, the first contact unit 431 of each movable contact 430 comes into contact with the outer surface 421a of the first fixed terminal 420A, while the second contact unit 432 also comes into contact with the outer surface 421a of the second fixed terminal 420B, and thereby, the first fixed terminal 420A and the second fixed terminal 420B are brought into electrical connection.

This configuration makes as small as possible the frictional force generated when the first contact units 431 are being brought into contact with or separated from the outer surface 421a of the first fixed terminal 420A. This configuration also makes as small as possible the frictional force generated when the second contact units 432 are being brought into contact with or separated from the outer surface 421a of the second fixed terminal 420B. This makes switching of the contact smoother.

The contact device 10 in this embodiment includes the pair of movable contacts 430. When the first fixed terminal 420A and the second fixed terminal 420B are electrically connected, the first contact unit 431 of one of the movable contacts 430 and the first contact unit 431 of the other movable contact 430 sandwich the first fixed terminal 420A. The second contact unit 432 of one of the movable contacts 430 and the second contact unit 432 of the other movable contact 430 also sandwich the second fixed terminal 420B.

In this configuration, the pair of movable contacts 430, 430 are provided in parallel, and this enables the direction of the current flowing through one of the movable contacts 430 and the direction of the current flowing through the other movable contact 430 to be approximately the same when the first fixed terminal 420A and the second fixed terminal 420B are electrically connected. When electric current flows in the same direction through members provided in parallel as described above, a mutually attracting force acts on the members provided in parallel.

Hence, when the first fixed terminal 420A and the second fixed terminal 420B are electrically connected, a mutually attracting force acts on the first contact units 431, 431 sandwiching the first fixed terminal 420A, and a mutually attracting force acts on the second contact units 432, 432 sandwiching the second fixed terminal 420B. This increases the force of the pair of movable contacts 430, 430 for sandwiching each fixed terminal 420, keeping the electrical connection between the first fixed terminal 420A and the second fixed terminal 420B more reliably.

In this embodiment, the distance D2 between the connecting portions 433, 433 is smaller in the state where the first fixed terminal 420A and the second fixed terminal 420B are electrically connected.

Specifically, the first contact unit 431 and the second contact unit 432 are connected to the connecting portion main body 434 to be bent, when viewed in the up-down direction, in the same direction relative to the connecting portion main body 434 (connecting portion 433) extending approximately in the front-back direction. Then, the first contact unit 431 and the second contact unit 432 are brought into contact with the tapered surfaces 421d (outer surfaces 421a) of the respective fixed terminals 420. In addition, the center portion of each of the first contact unit 431 and the second contact unit 432 comes into contact with the tapered surface 421d (outer surface 421a) of the corresponding fixed terminal 420 at an inner portion in the front-back direction of the tapered surface 421d (a portion of each fixed terminal 420 closer to the other fixed terminal 420 than its own center axis).

Thus, in this embodiment, the distance D2 between the connecting portions 433, 433 is smaller than the distance D3 between the portion of the first contact unit 431 of one of the movable contacts 430 that comes into contact with the tapered surface 421d (outer surface 421a) of the first fixed terminal 420A and the portion of the first contact unit 431 of the other movable contact 430 that comes into contact with the tapered surface 421d (outer surface 421a) of the first fixed terminal 420A.

This configuration makes the flows of the current flowing in the same direction through the paired movable contacts 430, 430 provided in parallel come closer to each other, increasing the mutually attracting force generated between the paired movable contacts 430, 430. This, in turn, makes it possible to keep the electrical connection between the first fixed terminal 420A and the second fixed terminal 420B more reliably.

In this embodiment, each of the first contact unit 431 and the second contact unit 432 is brought into contact with the tapered surface 421d (outer surface 421a) of the corresponding fixed terminals 420 at its inner portion in the front-back direction (a portion of each fixed terminal 420 closer to the other fixed terminal 420 than its own center axis). This configuration causes electromagnetic repulsive force between the first fixed terminal 420A and the first contact unit 431 in an oblique direction (inward in the front-back direction and outward in the right-left direction). The configuration also causes electromagnetic repulsive force between the second fixed terminal 420B and the second contact unit 432 in an oblique direction (inward in the front-back direction and outward in the right-left direction). In other words, the electromagnetic repulsive force is generated in a direction intersecting the rotation direction of the movable contacts 430, 430 (the right-left direction).

When the electromagnetic repulsive force occurs, this configuration makes small the component force of the electromagnetic repulsive force in the right-left direction transmitted from the fixed terminal 420 to the movable contact 430, and this can prevent more reliably the movable contact 430 from separating from the fixed terminal 420.

Note that the contact device 10 is not limited to the configuration described in the above embodiment but may have various configurations.

For example, the contact device 10 may have a configuration shown in FIG. 9.

Specifically, as with the movable contact 430 described in the above embodiment, the movable contact 430 shown in FIG. 9 has a first contact unit 431 and a second contact unit 432 that are connected to a connecting portion main body 434 to be bent, when viewed in the up-down direction, in the same direction relative to the connecting portion main body 434 (connecting portion 433) extending approximately in the front-back direction.

In addition, for the movable contact 430 shown in FIG. 9, the distal ends of the first contact unit 431 and the second contact unit 432 are bent so as to extend approximately in the front-back direction when viewed in the up-down direction.

With this configuration, the first contact units 431, 431 of the movable contacts 430 sandwich the first fixed terminal 420A from its both right and left sides, and the second contact units 432, 432 sandwich the second fixed terminal 420B from its both right and left sides.

Thus, in the contact device 10 shown in FIG. 9, the electromagnetic repulsive force transmitted from the fixed terminals 420 to each movable contact 430 is generated in a direction that approximately agrees with the rotation direction of each of the movable contacts 430, 430 (the right-left direction).

Thus, the configuration of the contact device 10 shown in FIG. 9 also provides the same operations and effects as in the above embodiment.

The contact device 10 may also have a configuration shown in FIG. 10.

The movable contact 430 shown in FIG. 10 has a shape the same as or a similar to the one shown in FIG. 9. In the contact device 10 shown in FIG. 10, each of the paired movable contacts 430 has a yoke 460 attached on its connecting portion 433, and a magnetic circuit is formed between the yoke 460 provided on one of the movable contacts 430 and the yoke 460 provided on the other movable contact 430.

Since the paired movable contacts 430, 430 are provided with the respective yokes 460 as described above, the current flowing through the paired movable contacts 430 causes magnetic force attracting one yoke 460 and the other yoke 460 to each other based on to the current. Then, due to the occurrence of the magnetic force attracting one yoke 460 and the other yoke 460 to each other, the one yoke 460 and the other yoke 460 attract each other. Then, this attraction between the one yoke 460 and the other yoke 460 presses the paired movable contacts 430, 430 against the first fixed terminal 420A and the second fixed terminal 420B.

Thus, the configuration of the contact device 10 shown in FIG. 10 also provides the same operations and effects as in the above embodiment.

Note that the number of yokes 460, the positions of the yokes 460 provided, and the shapes of the yokes 460 are not limited to those shown in FIG. 10, and yokes 460 in various shapes may be provided at any positions on the movable contacts 430. In addition, the yokes 460 may be provided to the movable contacts 430 shown in the above embodiment, or the yokes 460 may be provided to the movable contacts 430 shown below.

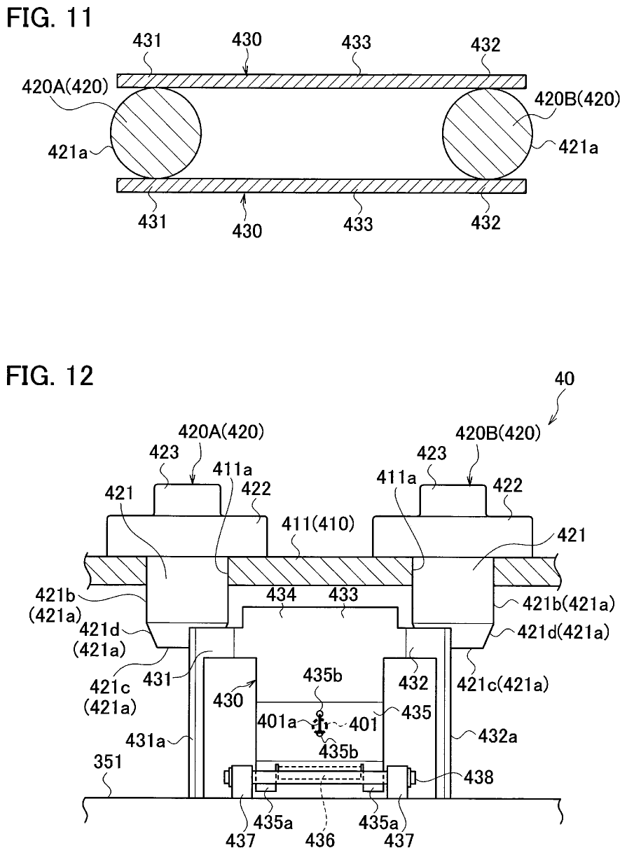

The contact device 10 may also have a configuration shown in FIG. 11.

The movable contacts 430 shown in FIG. 11 are formed such that the entireties of them extend approximately in the front-back direction when viewed in the up-down direction.

Hence, in the contact device 10 shown in FIG. 11, the first contact units 431, 431 of the movable contacts 430 sandwich the first fixed terminal 420A from its both right and left sides, and the second contact units 432, 432 sandwich the second fixed terminal 420B from its both right and left sides. Thus, in the contact device 10 shown in FIG. 11, the electromagnetic repulsive force transmitted from each fixed terminal 420 to the movable contacts 430 is generated in a direction that approximately agrees with the rotation direction of each of the movable contacts 430, 430 (the right-left direction).

Thus, also the configuration of the contact device 10 shown in FIG. 11 provides the same operations and effects as in the above embodiment.

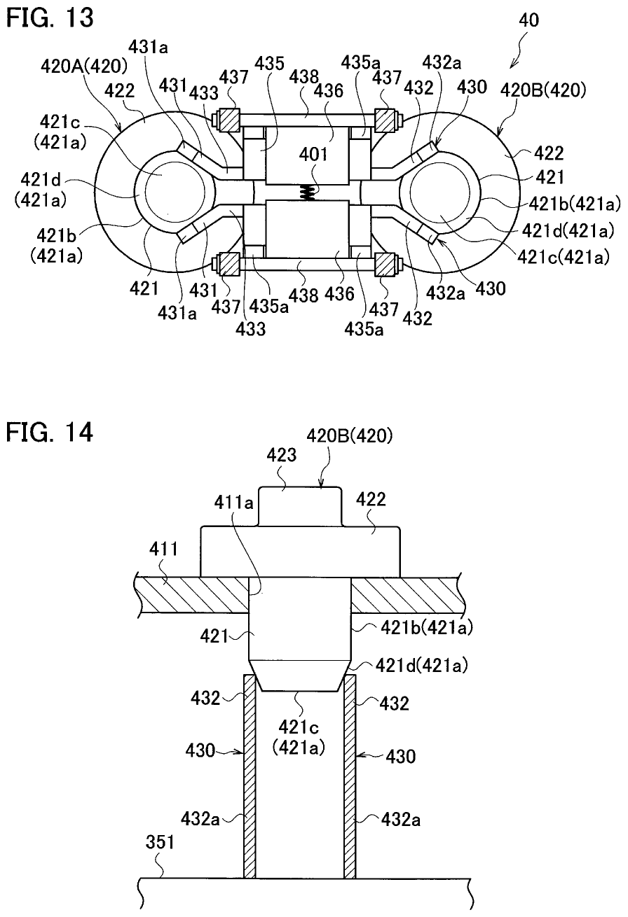

The contact device 10 may also have a configuration shown in FIGS. 12 to 14.

The movable contact 430 shown in FIGS. 12 to 14 has a support leg (support member) 431a to support the first contact unit 431 so as to prevent the first contact unit 431 in contact with the outer surface 421a of the fixed terminal 420 from moving in the direction away from the fixed terminals 420.

This support leg 431a is connected to the lower end of the first contact unit 431 and extends downward from the lower end of the first contact unit 431. When the first contact unit 431 is brought into contact with the outer surface 421a of the fixed terminal 420, the lower end of the support leg 431a comes into contact with the upper surface of the yoke upper plate 351 to support the first contact unit 431.

In addition, the movable contact 430 shown in FIGS. 12 to 14 has also a support leg (support member) 432a to support the second contact unit 432 so as to prevent the second contact unit 432 in contact with the outer surface 421a of the fixed terminal 420 from moving in the direction away from the fixed terminals 420.

This support leg 432a also is connected to the lower end of the second contact unit 432 and extends downward from the lower end of the second contact unit 432.

When the second contact unit 432 is brought into contact with the outer surface 421a of the fixed terminal 420, the lower end of the support leg 432a comes into contact with the upper surface of the yoke upper plate 351 to support the second contact unit 432.

Thus, the configuration of the contact device 10 shown in FIGS. 12 to 14 also provides the same operations and effects as in the above embodiment.

The movable contact 430 shown in FIGS. 12 to 14 has the support leg (support member) 431a to support the first contact unit 431 so as to prevent the first contact unit 431 in contact with the outer surface 421a of the fixed terminal 420 from moving in the direction away from the fixed terminals 420.

When the movable contact 430 has the support leg (support member) 431a as described above, the support leg (support member) 431a receives part of the electromagnetic repulsive force transmitted from each fixed terminal 420 to the movable contact 430, and this can prevent more reliably the movable contact 430 from separating from the fixed terminal 420.

In addition, the movable contact 430 shown in FIGS. 12 to 14 has the support leg (support member) 432a to support the second contact unit 432 so as to prevent the second contact unit 432 in contact with the outer surface 421a of the fixed terminal 420 from moving in the direction away from the fixed terminals 420.

When the movable contact 430 has the support leg (support member) 432a as described above, the support leg (support member) 432a also receives part of the electromagnetic repulsive force transmitted from each fixed terminal 420 to the movable contact 430, and this can prevent much more reliably the movable contact 430 from separating from the fixed terminal 420.

Thus, the configuration shown in FIGS. 12 to 14 further improves the contact reliability of the contact.

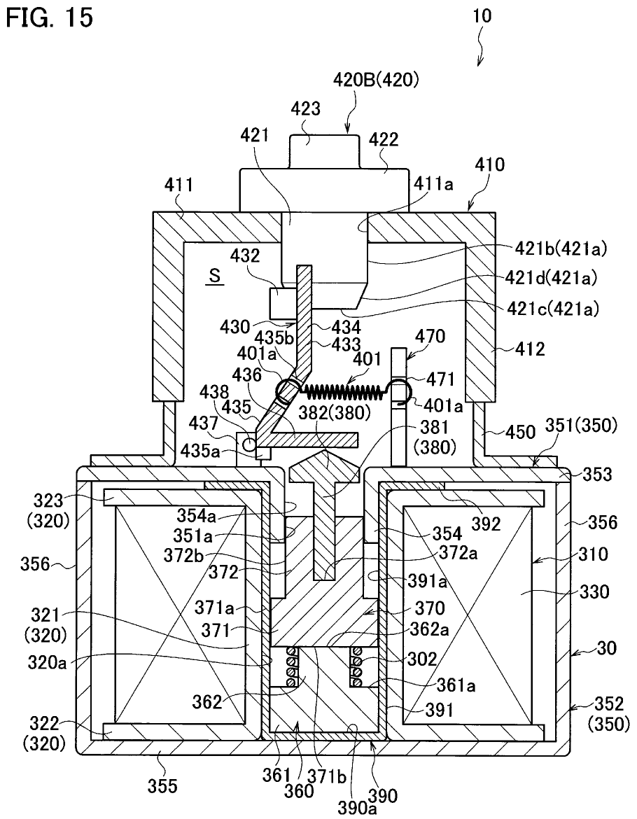

The contact device 10 may also have a configuration shown in FIG. 15.

This contact device 10 shown in FIG. 15 has one movable contact 430. When the one movable contact 430 is rotated in the right-left direction, the first contact unit 431 of the one movable contact 430 is brought into contact with the outer surface 421a of the first fixed terminal 420A. The second contact unit 432 of the one movable contact 430 also is brought into contact with the outer surface 421a of the second fixed terminal 420B. Thus, the first fixed terminal 420A and the second fixed terminal 420B are brought into electrical connection.

Note that FIG. 15 illustrates an example in which one movable contact 430 is arranged on one side in the right-left direction to be rotatable in the right-left direction, and in which a support wall 470 is arranged on the other side in the right-left direction to be fixed on the yoke upper plate 351.

One of the hook portions 401a formed at both ends of a contact pressure spring 401 is hooked in engagement holes 435b formed in an extension portion 435 of the one movable contact 430, while the other hook portion 401a is hooked in engagement holes 471 formed in the support wall 470. Thus, the one movable contact 430 and the support wall 470 are connected via the contact pressure spring 401.

Thus, the configuration of the contact device 10 shown in FIG. 15 also provides approximately the same operations and effects as in the above embodiment.

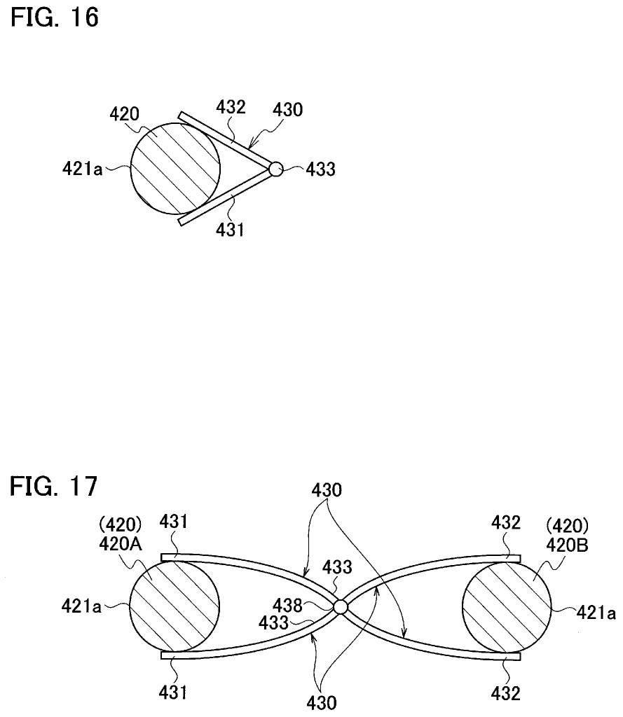

The contact device 10 may also have a configuration shown in FIG. 16.

The contact device 10 shown in FIG. 16 has one fixed terminal 420. When a first contact unit 431 and a second contact unit 432 of the one movable contact 430 are brought into contact with the outer surface 421a of the one fixed terminal 420, the contact turns on.

Specifically, in the movable contact 430 shown in FIG. 16, the first contact unit 431 and the second contact unit 432 are configured to be rotatable in the right-left direction on a rotation shaft (connecting portion 433) extending in the up-down direction.

This movable contact 430 shown in FIG. 16 is attached to the shaft 380, for example, via a conversion mechanism that converts linear motion into rotary motion, and thereby, the movable contact 430 can be rotated along with the reciprocation of the shaft 380 in the up-down direction.

Then, along with the movement of the shaft 380 in one direction, the first contact unit 431 and the second contact unit 432 of the movable contact 430 are rotated in directions toward each other, and thereby, the first contact unit 431 and the second contact unit 432 sandwich the fixed terminal 420. In this state, current approximately in the same direction flows through the first contact unit 431 and the second contact unit 432, and thus, when the contact is on, a mutually attracting force acts on the first contact unit 431 and the second contact unit 432.

Thus, the configuration of the contact device 10 shown in FIG. 16 also provides approximately the same operations and effects as in the above embodiment.

The contact device 10 may also have a configuration shown in FIG. 17.

This contact device 10 shown in FIG. 17 includes two movable contacts 430, 430 in approximately in an S shape when viewed in the up-down direction, and these two approximately S-shaped movable contacts 430 are arranged to intersect each other at their centers in the front-back direction. The movable contacts 430 are configured to rotate in the right-left direction on a rotation shaft 438 provided at the intersecting portion and extending in the up-down direction.

These two movable contacts 430 shown in FIG. 17 also are attached to the shaft 380, for example, via a conversion mechanism that converts linear motion into rotary motion, and thereby, each movable contact 430 can be rotated along with the reciprocation of the shaft 380 in the up-down direction.

Thus, the configuration of the contact device 10 shown in FIG. 17 also provides approximately the same operations and effects as in the above embodiment.

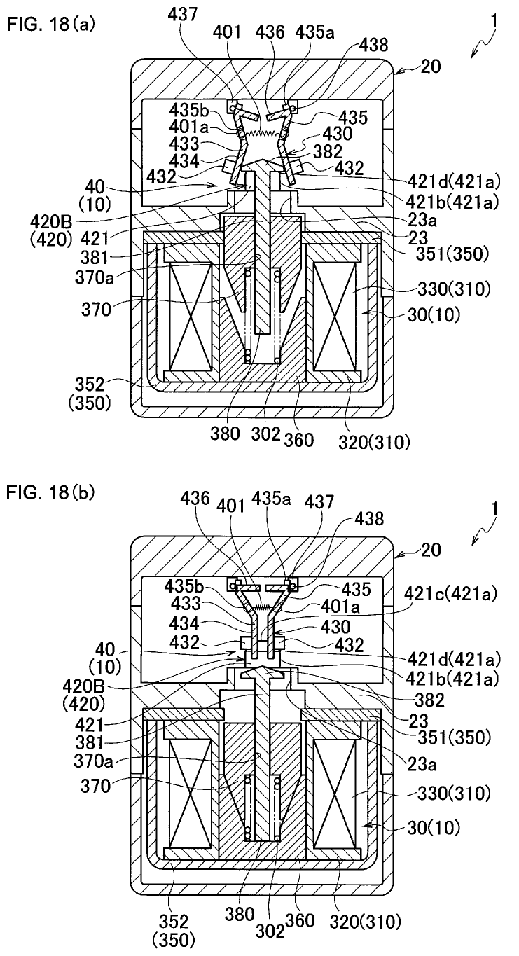

The contact device 10 may also have a configuration shown in FIG. 18.

The electromagnetic relay 1 shown in FIG. 18 is equipped with a contact device 10 with a configuration in which a drive block (drive unit) 30 located below and a contact block (contact unit) 40 located above are integrally combined. To be more specific, in the electromagnetic relay 1 equipped with the contact device 10, the contact device 10 is housed in a case 20 formed of a resin material into an approximately hollow box shape.

The drive block 30 includes a coil unit 310. The coil unit 310 includes a coil 330 that generates a magnetic flux when energized, and a hollow cylindrical coil bobbin 320 around which the coil 330 is wound.

When the coil 330 is energized, the drive block 30 is driven, and the drive of the drive block 30 opens and closes the contacts of the contact block 40. In the electromagnetic relay 1 shown in FIG. 18, again, the contact block 40 has a pair of contacts formed herein. In FIG. 18, one of the contacts of the contact block 40 is formed by the first fixed terminal 420A and a portion of the movable contact 430 that comes into contact with the first fixed terminal 420A. The other contact is formed by the second fixed terminal 420B and a portion of the movable contact 430 that comes into contact with the second fixed terminal 420B. Thus, in FIG. 18, again, opening and closing of the contacts of the contact block 40 can be switched by driving the drive block 30 or stopping the drive of the drive block 30. That is, the electrical connection and disconnection between the first fixed terminal 420A and the second fixed terminal 420B can be switched by switching on and off of the drive block 30. Note that FIG. 18 does not include illustration of the first fixed terminal 420A, but the first fixed terminal 420A is supposed to be arranged on the near side in the direction orthogonal to the drawing plane of FIG. 18.

The drive block 30 includes a yoke 350 disposed around the coil 330. The yoke 350 can be formed of a magnetic material, for example, and includes a rectangular yoke upper plate 351 disposed on the upper end surface side of the coil bobbin 320 and a rectangular yoke main body 352 disposed on a lower end surface side and side surface sides of the coil bobbin 320.

The drive block 30 also includes a fixed iron core (fixed-side member) 360 that is in the cylinder of the coil bobbin 320 and is magnetized by the coil 330 when it is energized. The drive block 30 further includes a movable iron core (movable-side member) 370 that is disposed inside the cylinder of the coil bobbin 320, facing the fixed iron core 360 in the up-down direction (axial direction).

Also in FIG. 18, the fixed iron core 360 is arranged below and the movable iron core 370 is arranged above. To be more specific, a return spring 302 is mounted on the upper surface of the fixed iron core 360, and the movable iron core 370 is disposed above the fixed iron core 360, being biased by the return spring 302 in a direction away from the fixed iron core 360.

The movable iron core 370 has an insertion hole 370a in its center, and a shaft (drive shaft) 380 is inserted into the insertion hole 370a.

The shaft 380 may be formed of, for example, a non-magnetic material. In FIG. 18, the shaft 380 includes: a shaft main body 381 having a round bar shape elongated in the moving direction of the movable iron core 370 (up-down direction: drive shaft direction); and an approximately umbrella-shaped head 382 connected to the upper part of the shaft main body 381. The movable iron core 370 and the shaft 380 are connected by inserting the lower end of the shaft main body 381 into the insertion hole 370a from above.

Above the drive block 30 is provided the contact block 40, which opens and closes the contacts according to the on/off state of the current supply to the coil 330.

The contact block 40 includes a first fixed terminal 420A and a second fixed terminal 420B spaced apart from the first fixed terminal 420A. The contact block 40 further includes movable contacts 430 that switch the connection and disconnection between the first and second fixed terminals 420A and 420B by moving relative to the first and second fixed terminals 420A and 420B.

Each fixed terminal 420 is formed of a conductive material such as a copper-based material and arranged to be elongated in the up-down direction in the state shown in FIG. 18. Each fixed terminal 420 in FIG. 18 includes a fixed terminal main body 421 (fixed terminal main body 421 elongated in the up-down direction) approximately in a columnar shape, and each fixed terminal main body 421 has, at its upper end, a tapered portion the diameter of which decreases toward the upper side.

Thus, the fixed terminal main body 421 of each fixed terminal 420 has an outer surface 421a having a side surface 421b extending in the vertical direction (the up-down direction), a bottom surface 421c extending in the horizontal direction (the front-back direction and the right-left direction), and a tapered surface 421d extending in an oblique direction.

The case 20 in FIG. 18 includes a partition wall 23 that partitions the internal space into the upper part and the lower part, and the partition wall 23 has, in its center, an insertion hole 23a through which the head 382 of the shaft 380 can pass. Then, the fixed terminal main bodies 421 are arranged on the partition wall 23 to be spaced apart from each other.

As described above, in FIG. 18, the first fixed terminal 420A and the second fixed terminal 420B are spaced apart from each other so as to be lined in the right-left direction.

In the space formed above the partition wall 23 of the case 20, the movable contacts 430 are disposed so as to be movable relative to the first and second fixed terminals 420A and 420B along with the up-down movement of the shaft 380.

The movable contacts 430 shown in FIG. 18 have approximately the same shapes as those of the movable contacts 430 shown in the above embodiment. Specifically, the movable contacts 430 shown in FIG. 18 have shapes in which the movable contacts 430 shown in the above embodiment are inverted upside down.

Specifically, the movable contact 430 shown in FIG. 18 is formed of an approximately plate-shaped member and includes a first contact unit 431 formed on one side of the movable contact 430, a second contact unit 432 formed on the other side of the movable contact 430, and a connecting portion 433 connecting the first contact unit 431 and the second contact unit 432. Note that the connecting portion 433 in FIG. 18 also includes the connecting portion main body 434, and the first contact unit 431 and the second contact unit 432 are respectively connected to both ends of this connecting portion main body 434.

The pair of movable contacts 430, 430 are arranged to face each other such that the pair of fixed terminals 420 (the first fixed terminal 420A and the second fixed terminal 420B) are positioned between the pair of movable contacts 430, 430.

Thus, also in FIG. 18, each movable contact 430 has a plate shape elongated in the front-back direction, including the first contact unit 431, the second contact unit 432, and the connecting portion main body 434. In addition, when viewed in the right-left direction, the connecting portion main body 434 (connecting portion 433) is positioned between the inner end of the first fixed terminal 420A (the portion closest to the second fixed terminal 420B) and the inner end of the second fixed terminal 420B (the portion closest to the first fixed terminal 420B).

Then, the first contact unit 431 extending to protrude on one side in the front-back direction of the connecting portion main body 434 (on the first fixed terminal 420A side) is formed, when viewed in the right-left direction, to face (overlap) the tapered surface 421d of the first fixed terminal 420A. The second contact unit 432 extending to protrude on the other side in the front-back direction of the connecting portion main body 434 (on the second fixed terminal 420B side) is formed, when viewed in the right-left direction, to face (overlap) the tapered surface 421d of the second fixed terminal 420B.

The first contact unit 431 and the second contact unit 432 are connected to the connecting portion main body 434 (connecting portion 433) so as to be bent, when viewed in the up-down direction, in the same direction relative to the connecting portion main body 434 extending approximately in the front-back direction.

Each movable contact 430 is arranged in the case 20 to be rotatable on a rotation shaft 438 extending in the front-back direction. Then, the reciprocation of the shaft 380 in the up-down direction rotates each movable contact 430 such that the first contact unit 431 and the second contact unit 432 come into contact with or separate from the fixed terminals 420.

Specifically, the connecting portion 433 includes an extension portion 435 connected to the upper end of the connecting portion main body 434 and extending upward, and the rotation shaft 438 is fixed to the upper end of this extension portion 435. Then, the rotation shaft 438 fixed to the upper end of the extension portion 435 is rotatably supported by a pair of bearings 437,437. This pair of bearings 437,437 are fixed on the lower surface of the top wall of the case 20.

In addition, to the upper end of the extension portion 435 is connected a piece portion 436 extending inward (extending toward the movable contact 430 on the other side). The piece portion 436 in FIG. 18 is formed integrally with the extension portion 435 by bending inward the center portion in the front-back direction of the upper end of the extension portion 435. Note that a configuration without the piece portion 436 may be possible. On both sides in the front-back direction of the upper end of the extension portion 435 are formed piece portions 435a extending upward, and the rotation shaft 438 is fixed to these piece portions 435a, 435a.

Also in FIG. 18, the pair of movable contacts 430, 430 are connected to each other via a contact pressure spring 401. The pair of movable contacts 430, 430 are biased in the directions toward each other (in the directions toward the fixed terminal 420) by this contact pressure spring 401. Thus, the contact pressure spring 401 provides the contact pressure between the movable contact 430 and the fixed terminal 420 also in in FIG. 18. The contact pressure spring 401 is a coil spring and is arranged with the axial direction oriented in the right-left direction. In FIG. 18, each of the hook portions 401a formed at both ends of the coil spring is hooked in engagement holes 435b formed in the extension portion 435 of each movable contact 430, and thereby the pair of movable contacts 430, 430 are connected to each other by the contact pressure spring 401.

With the movable contacts 430 as described above, when the shaft (moving body, drive shaft) 380 moves downward (in one direction) in the up-down direction (moving direction), the head 382 of the shaft 380 also moves downward. When the head 382 of the shaft 380 moves downward, the head 382 of the shaft 380 moves away from the pair of connecting portion main bodies 434. As a result, the paired movable contacts 430, 430 are rotated by the biasing force (elastic restoring force) of the contact pressure spring 401 such that their lower sides come close to each other. When the lower sides of the paired movable contacts 430, 430 rotate in the directions toward each other as described above, the first contact units 431 move relative to the first fixed terminal 420A and come into contact with the tapered surface 421d (outer surface 421a) of the first fixed terminal 420A. The second contact units 432 also move relative to the second fixed terminal 420B and come into contact with the tapered surface 421d (outer surface 421a) of the second fixed terminal 420B. Thus, the first fixed terminal 420A and the second fixed terminal 420B are brought into electrical connection.

On the other hand, when the shaft (the drive shaft) 380 moves upward (in the other direction) in the up-down direction (moving direction), the head 382 of the shaft 380 also move upward. When the head 382 of the shaft 380 moves upward, the distal end of the head 382 gets into between the paired connecting portion main bodies 434. As a result, the paired movable contacts 430, 430 rotate against the biasing force (elastic restoring force) of the contact pressure spring 401 such that their lower sides move away from each other. When the lower sides of the paired movable contacts 430, 430 rotate in the direction away from each other as described above, the first contact units 431 move relative to the first fixed terminal 420A and separate from the tapered surface 421d (the outer surface 421a) of the first fixed terminal 420A. The second contact units 432 also move relative to the second fixed terminal 420B and separate from the tapered surface 421d (the outer surface 421a) of the second fixed terminal 420B. Thus, the first fixed terminal 420A and the second fixed terminal 420B are electrically disconnected.

As described above, the drive block (drive unit) 30 in FIG. 18 also has the shaft (moving body, drive shaft) 380 that drives (moves) the movable contacts 430.

Then, the movement of the shaft (moving body) 380 in the up-down direction (moving direction) causes the relative rotation (relative movement) of the movable contacts 430 in the right-left direction relative to the pair of fixed terminals 420, and this operation switches the conduction and non-conduction between the fixed terminals.

Here, the first contact unit 431 rotates in a direction approximately orthogonal to (intersecting) the extending directions of the tangent plane to the portion of the outer surface 421a of the first fixed terminal 420A with which the first contact unit 431 comes into contact. Specifically, in FIG. 18, the first contact unit 431 separates from the tapered surface 421d (outer surface 421a) by moving in a direction that is different from the moving direction (up-down direction) of the shaft (moving body) 380 and that intersects the extending directions of the portion that makes contact with the first contact unit 431 of the tapered surface 421d (outer surface 421a).

The second contact unit 432 also rotates in a direction approximately orthogonal to (intersecting) the extending directions of the tangent plane to the portion of the outer surface 421a of the second fixed terminal 420B with which the second contact unit 432 comes into contact. Hence, in FIG. 18, the second contact unit 432 also separates from the tapered surface 421d (outer surface 421a) by moving in a direction that is different from the moving direction (up-down direction) of the shaft (the moving body) 380 and that intersects the extending directions of the portion that makes contact with the second contact unit 432 of the tapered surface 421d (outer surface 421a).

In FIG. 18, the first contact unit 431 of the movable contact 430 arranged on the left side in the right-left direction comes into contact with the tapered surface 421d (outer surface 421a) of the first fixed terminal 420A by rotating in the right direction. The first contact unit 431 of the movable contact 430 arranged on the right side in the right-left direction comes into contact with the tapered surface 421d (outer surface 421a) of the first fixed terminal 420A by rotating in the left direction.

The second contact unit 432 of the movable contact 430 arranged on the left side in the right-left direction comes into contact with the tapered surface 421d (outer surface 421a) of the second fixed terminal 420B by rotating in the right direction. The second contact unit 432 of the movable contact 430 arranged on the right side in the right-left direction comes into contact with the tapered surface 421d (outer surface 421a) of the second fixed terminal 420B by rotating in the left direction.

As described above, also in FIG. 18, when the first fixed terminal 420A and the second fixed terminal 420B are electrically connected, the first contact unit 431 of one of the movable contacts 430 and the first contact unit 431 of the other movable contact 430 sandwich the first fixed terminal 420A. The second contact unit 432 of one of the movable contacts 430 and the second contact unit 432 of the other movable contact 430 also sandwich the second fixed terminal 420B.

This configuration also provides the same operations and effects as those of the electromagnetic relay 1 and the contact device 10 described in the above embodiment.

Although the preferred embodiment of the present invention has been described above, the present invention is not limited to the above embodiment, and various modifications are possible.

For example, a contact device can be formed by appropriately combining the configurations described in the above embodiments and modified examples thereof.

The present invention is also applicable to a contact device having three or more fixed terminals.

Although the above embodiments and the modifications thereof are examples in which the first contact unit and the second contact unit are brought into point contact with the fixed terminals, the present invention is not limited to those examples. For example, in the case of a configuration in which the first contact unit and the second contact unit are brought into contact with the tapered surfaces of the fixed terminals in a columnar shape, the first contact unit and the second contact unit may be deformed to be twisted relative to the connecting portion so that the first contact unit and the second contact unit can be brought into line contact with the fixed terminals. Alternatively, the first contact unit and the second contact unit may be curved so that the first contact unit and the second contact unit can be brought into surface contact with the fixed terminals.

The specifications (shape, size, layout, and the like) of each fixed terminal, movable contact, and other details also can be appropriately changed.

This application claims priority based on Japanese Patent Application No. 2017-188537 filed on Sep. 28, 2017, the entire contents of which are incorporated herein by reference.

### INDUSTRIAL APPLICABILITY

The present invention provides a contact device capable of switching the contact more smoothly and an electromagnetic relay equipped with the contact device.

1. A contact device comprising:
a fixed terminal;
a movable contact that comes into contact with and away from the fixed terminal; and
a drive unit including a moving body that moves the movable contact, wherein
the movable contact includes
a first contact unit that is formed on one side of the movable contact and comes into contact with an outer surface of the fixed terminal,
a second contact unit that is formed on the other side of the movable contact and comes into contact with an outer surface of the fixed terminal, and
a connecting portion connecting the first contact unit and the second contact unit,
the first contact unit separates from the outer surface by moving in a direction that is different from a moving direction of the moving body and that intersects an extending direction of a portion that makes contact with the first contact unit of the outer surface, and
the second contact unit separates from the outer surface by moving in a direction that is different from the moving direction of the moving body and that intersects an extending direction of a portion that makes contact with the second contact unit of the outer surface.

2. The contact device according to claim 1, wherein
the fixed terminal includes a first fixed terminal and a second fixed terminal spaced apart from the first fixed terminal, and
the first fixed terminal and the second fixed terminal are brought into electrical connection by the first contact unit of the movable contact coming into contact with an outer surface of the first fixed terminal and the second contact unit coming into contact with an outer surface of the second fixed terminal.

3. The contact device according to claim 2, further comprising
a pair of the movable contacts, wherein
in a state where the first fixed terminal and the second fixed terminal are electrically connected, the first fixed terminal is sandwiched between a first contact unit of one of the movable contacts and a first contact unit of the other one of the movable contacts, and the second fixed terminal is sandwiched between a second contact unit of the one movable contact and a second contact unit of the other movable contact.

4. The contact device according to claim 3, wherein in a state where the first fixed terminal and the second fixed terminal are electrically connected, the distance between a connecting portion of the one movable contact and a connecting portion of the other movable contact is smaller than the distance between a contact portion that is in contact with the outer surface of the first fixed terminal of the first contact unit of the one movable contact and a contact portion that is in contact with the outer surface of the first fixed terminal of the first contact unit of the other movable contact.

5. The contact device according to claim 1, wherein the movable contact has a support member that supports the first contact unit to prevent the first contact unit in contact with the outer surface of the fixed terminal from moving in a direction away from the fixed terminal.

6. The contact device according to claim 1, wherein the movable contact has a support member that supports the second contact unit to prevent the second contact unit in contact with the outer surface of the fixed terminal from moving in a direction away from the fixed terminal.

7. An electromagnetic relay comprising the contact device according to claim 1.
